(19) United States
(12) Patent Application Publication
(10) Pub. No.: US 2021/0300094 A1
(43) Pub. Date: Sep. 30, 2021

(54) HEAD UNIT AND IMAGE FORMING DEVICE

(71) Applicant: KYOCERA Document Solutions Inc., Osaka-shi (JP)

(72) Inventor: Hiroyuki TOMIOKA, Osaka-shi (JP)

(21) Appl. No.: 17/212,208

(22) Filed: Mar. 25, 2021

(30) Foreign Application Priority Data
Mar. 26, 2020 (JP) 2020-055962

(51) Int. Cl. B41J 25/308; B41J 2/01

(52) U.S. Cl. CPC B41J 25/308; B41J 2/01

(57) ABSTRACT

A head unit includes a mount (first mount). An inkjet head includes a nozzle for ejecting ink. The mount includes a Z-direction biasing member and a Z-direction positioning member. The Z-direction positioning member positions the inkjet head in an ink ejecting direction (Z (+) direction, lower direction) of the nozzle by holding a sphere to be rotatable, and bringing the sphere into contact with the inkjet head. The Z-direction biasing member biases the inkjet head against the Z-direction positioning member.

### INCORPORATION BY REFERENCE

This application is based upon, and claims the benefit of priority from, corresponding Japanese Patent Application No. 2020-055962 filed in the Japan Patent Office on Mar. 26, 2020, the entire contents of which are incorporated herein by reference.

### BACKGROUND

### Field of the Invention

The present disclosure relates to a head unit and an image forming device.

### Description of Related Art

In a typical head support structure, a step portion is formed on a recording head, and an X-axis positioning convex portion and a Y-axis positioning convex portion are formed on the step portion for fixing the recording head to a head base. Further, a leaf spring is provided on a head holder to position the recording head with respect to the head holder.

### SUMMARY

According to an aspect of the present disclosure, a head unit includes a mount on which an inkjet head is positioned. The inkjet head includes a nozzle for ejecting ink. The mount includes a Z-direction positioning member and a Z-direction biasing member. The Z-direction positioning member positions the inkjet head in the ink ejecting direction of the nozzle by gripping a sphere to be rotatable and bringing the sphere into contact with the inkjet head. The Z-direction biasing member biases the inkjet head to the positioning member.

### BRIEF DESCRIPTION OF THE DRAWINGS

FIG. 1 is a diagram illustrating an image forming device according to a first embodiment of the present disclosure;

FIG. 2 is a perspective view illustrating a headset in which an inkjet head is mounted on a head unit according to the first embodiment of the present disclosure;

FIG. 3 is a perspective view illustrating an inkjet head to be mounted on the head unit according to the first embodiment;

FIG. 4 is a perspective view illustrating the head unit according to the first embodiment;

FIG. 5 is an enlarged perspective view illustrating the head unit according to the first embodiment;

FIG. 6 is an enlarged perspective view illustrating a first mount provided in the head unit according to the first embodiment;

FIG. 7 is a cross-sectional view of the first mount provided in the head unit according to the first embodiment;

FIG. 8 is an enlarged perspective view illustrating a second mount provided in the head unit according to the first embodiment;

FIG. 9 is an external perspective view illustrating a Z-direction positioning member provided in the head unit according to the first embodiment;

FIG. 10 is a cross-sectional view illustrating the Z-direction positioning member provided in the head unit according to the first embodiment;

FIG. 11 is a top view illustrating a head unit according to a second embodiment;

FIG. 12 is a top view illustrating a head unit according to the second to seventh embodiments, and is an enlarged view of FIG. 11; and

FIG. 13 is a cross-sectional view illustrating a Z-direction positioning member provided in a head unit according to an eighth embodiment.

### DETAILED DESCRIPTION

### First Embodiment

Hereinafter, a first embodiment of the present disclosure will be described with reference to the drawings. It should be noted that, in the drawings, the same or corresponding portions are denoted by the same reference numerals, and the description thereof will not be repeated.

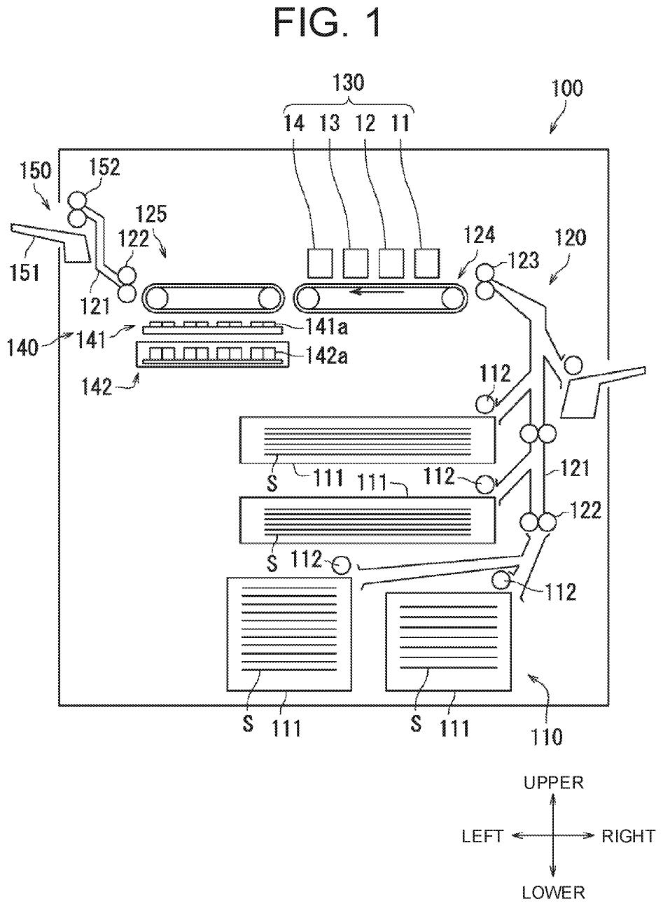

An image forming device 100 according to a first embodiment will be described with reference to FIG. 1. FIG. 1 is a diagram illustrating the image forming device 100 according to the first embodiment of the present disclosure.

As illustrated in FIG. 1, the image forming device 100 includes a feeding unit 110, a sheet conveyance unit 120, an image forming unit 130, a maintenance unit 140, and a discharging unit 150.

The feeding unit 110 feeds a sheet S to the sheet conveyance unit 120. The feeding unit 110 of the first embodiment includes a sheet feeding cassette 111 and a sheet feeding roller 112. The sheet feeding cassette 111 accommodates the sheet S. The sheet feeding roller 112 feeds the sheet S from the sheet feeding cassette 111 to the sheet conveyance unit 120. The sheet S is an example of a recording medium.

The sheet conveyance unit 120 conveys the sheet S to the discharging unit 150. Specifically, the sheet conveyance unit 120 includes a plurality of conveyance guides 121, a plurality of conveyance roller pairs 122, and a registration roller pair 123. The conveyance guide 121 constitutes a part of the sheet conveyance unit 120. The conveyance roller pair 122 conveys the sheet S along the conveyance guide 121. The registration roller pair 123 adjusts the timing of conveying the sheet S to an area opposite to headsets 11 to 14.

The sheet conveyance unit 120 of the first embodiment includes a first conveyance unit 124 and a second conveyance unit 125. The first conveyance unit 124 faces the headsets 11 to 14. The first conveyance unit 124 conveys the sheet S in an area immediately below the headsets 11 to 14. The second conveyance unit 125 conveys the sheet S fed from the first conveyance unit 124 toward the discharging unit 150.

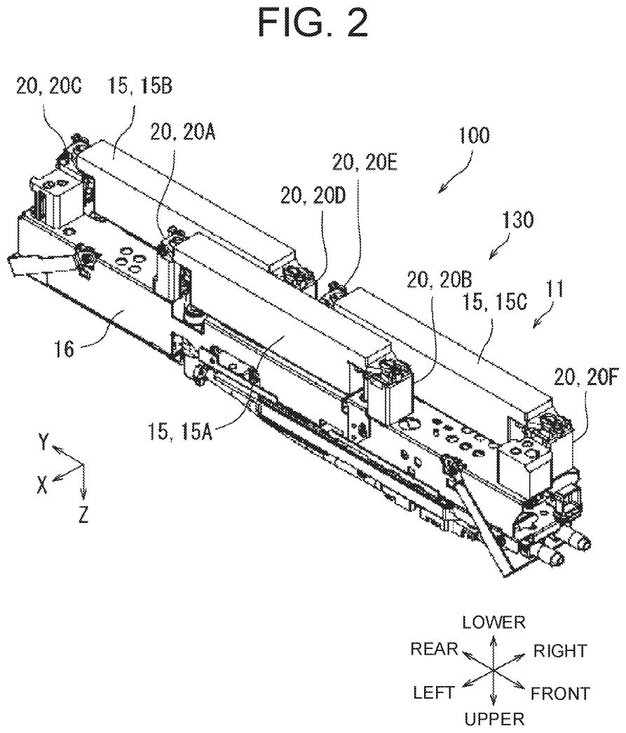

The image forming unit 130 forms an image on the sheet S by a head unit 16 (FIG. 2). The image forming unit 130 includes the headset 11, the headset 12, the headset 13, and the headset 14.

As will be described later in FIG. 2, an inkjet head 15 (inkjet head 15A, inkjet head 15B, and inkjet head 15C), which is attached to the head unit 16 of the headset 11, ejects ink toward the sheet S conveyed by the first conveyance unit 124 in FIG. 1. The inkjet head 15 of each of the headsets 12 to 14 similarly ejects ink toward the sheet S.

The inkjet heads 15 of the headsets 11 to 14 eject ink of different colors. For example, the inkjet head 15 of the headset 11 ejects black ink. The inkjet head 15 of the headset 12 ejects cyan ink. The inkjet head 15 of the headset 13 ejects magenta ink. The inkjet head 15 of the headset 14 ejects yellow ink.

The maintenance unit 140 maintains the inkjet heads 15 of the headsets 11 to 14. The maintenance unit 140 is positioned below the second conveyance unit 125 when an image is recorded on the sheet S, and moves to a position immediately below the headsets 11 to 14 when the inkjet head 15 is maintained.

Note that when the inkjet head 15 is maintained, the first conveyance unit 124 is moved to the retraction position. The retraction position is a position where the first conveyance unit 124 does not collide with the maintenance unit 140.

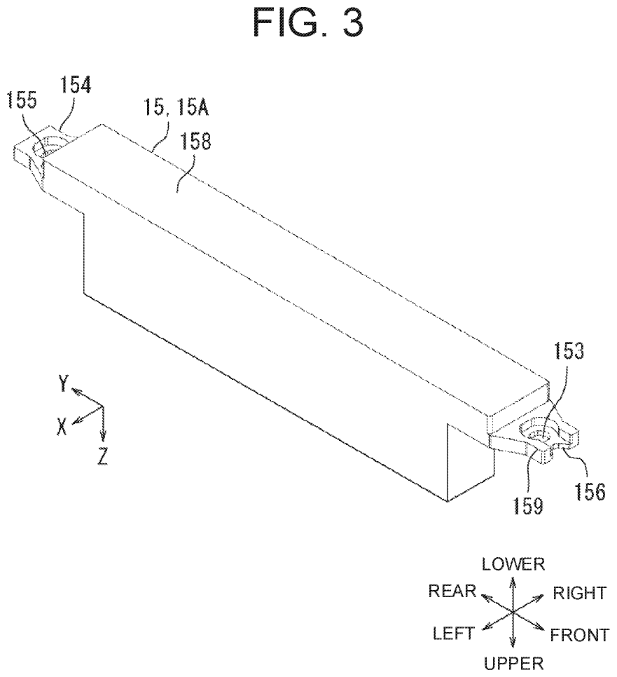

The maintenance unit 140 of the first embodiment includes a cap portion 141 and a cleaning unit 142. As will be described later in FIG. 3, the inkjet head 15 includes a nozzle surface 158. As illustrated in FIG. 1, the cap portion 141 includes a capping member 141a. The capping member 141a caps the nozzle surface 158 of the inkjet head 15 to provide an environment which prevents the ink from easily drying.

The cleaning unit 142 cleans the nozzle surface 158 of the inkjet head 15. Specifically, the cleaning unit 142 includes a wipe blade 142a. The wipe blade 142a includes, for example, a resin as a material. The wipe blade 142a is a cleaning member for cleaning the nozzle surface 158.

The cleaning unit 142 moves the wipe blade 142a along the Y-axis direction to the nozzle surface 158 of the inkjet head 15 in FIG. 3 under the condition that the wipe blade 142a contacts with the lower surface of the inkjet head 15. As a result, the nozzle surface 158 is wiped by the wipe blade 142a, and the nozzle surface 158 is cleaned. Specifically, the ink adhering to the nozzle surface 158 is wiped off by the wipe blade 142a.

The discharging unit 150 discharges the sheet S to the outside of the image forming device 100. The discharging unit 150 of the first embodiment includes a discharge tray 151 and a discharge roller pair 152. The discharge roller pair 152 feed the sheet S to the discharge tray 151.

Next, the head unit 16 of the image forming device 100 according to the first embodiment will be described with reference to FIGS. 2 to 10 in addition to FIG. 1. FIG. 2 is a perspective view illustrating the headset 11 in which the inkjet head 15 is mounted on the head unit 16 according to the first embodiment of the present disclosure. FIG. 3 is a perspective view illustrating the inkjet head 15 to be mounted on the head unit 16 according to the first embodiment.

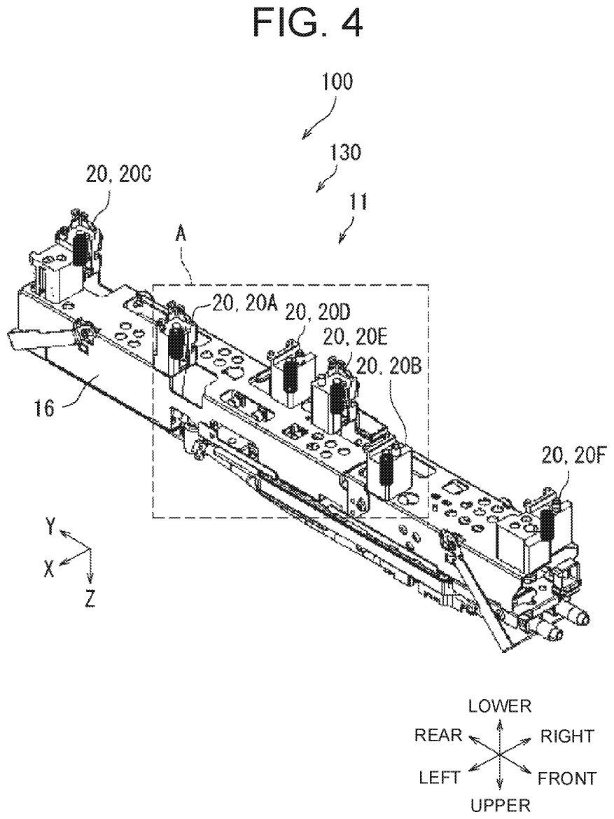

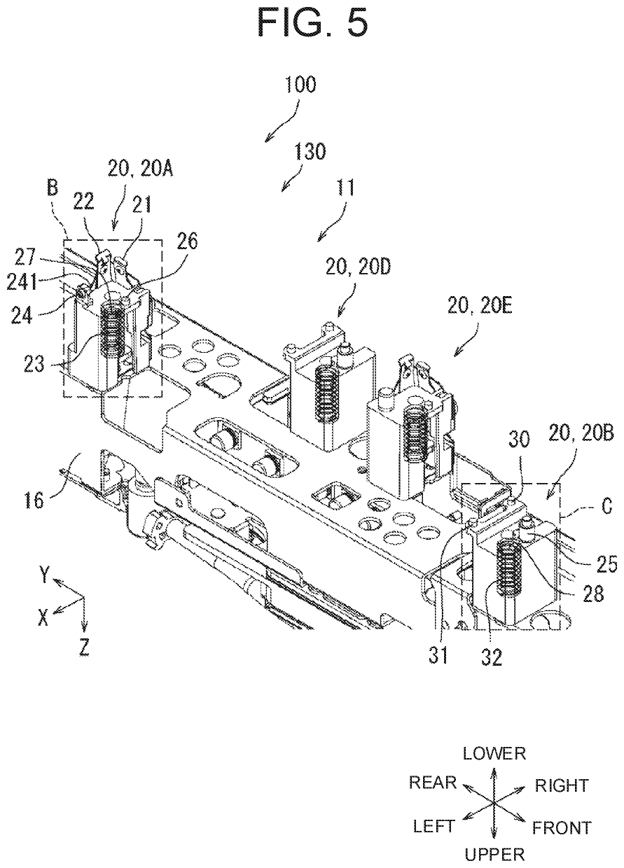

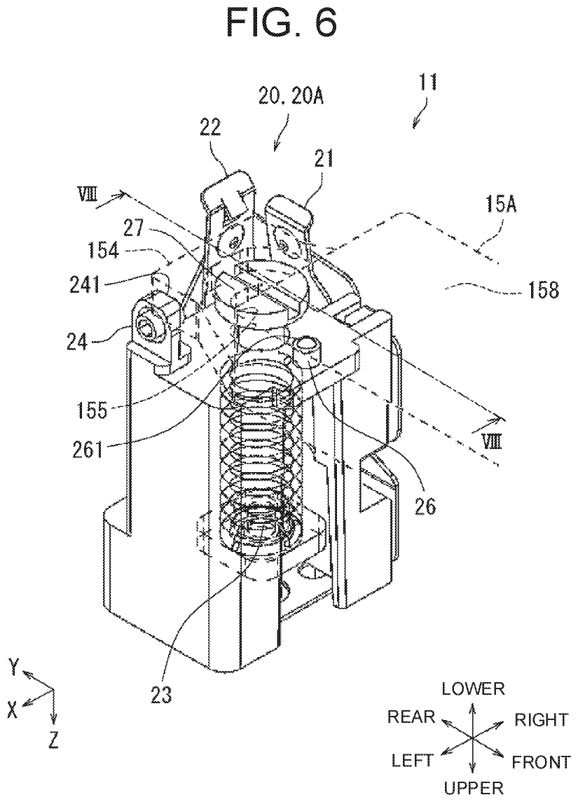

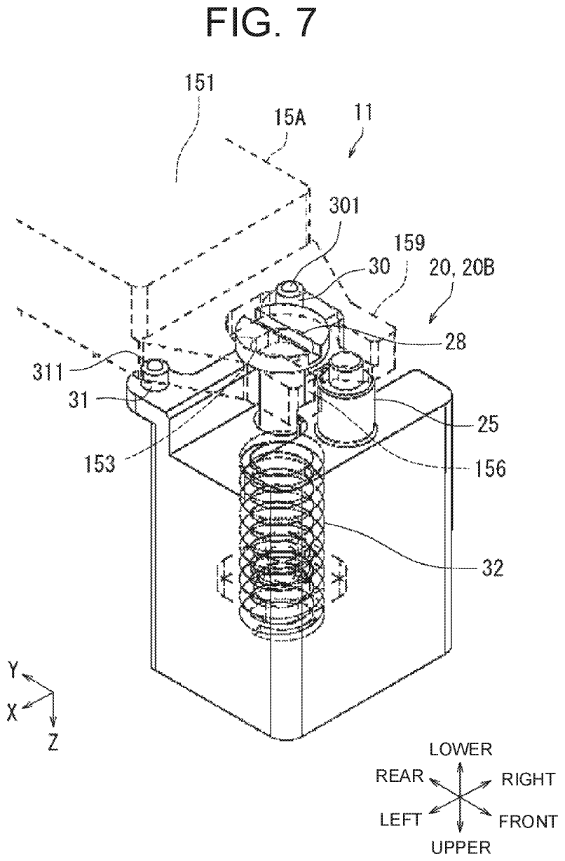

FIG. 4 is a perspective view illustrating the head unit 16 according to the first embodiment. FIG. 5 is an enlarged perspective view illustrating the head unit 16 according to the first embodiment. FIG. 6 is an enlarged perspective view illustrating a first mount 20A provided in the head unit 16 according to the first embodiment. FIG. 7 is a cross-sectional view of the first mount 20A provided in the head unit 16 according to the first embodiment.

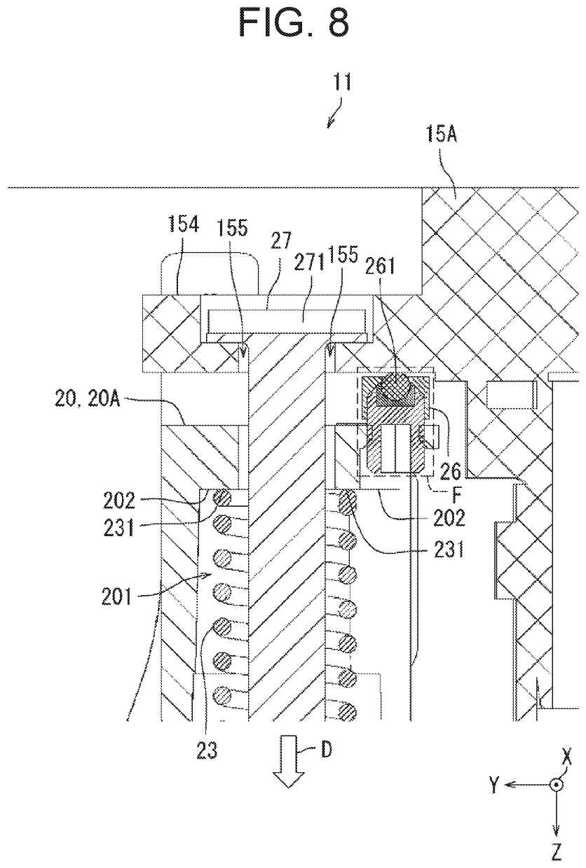

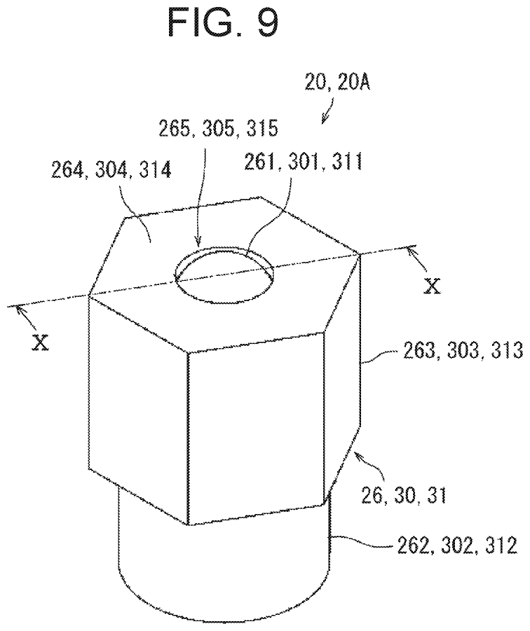

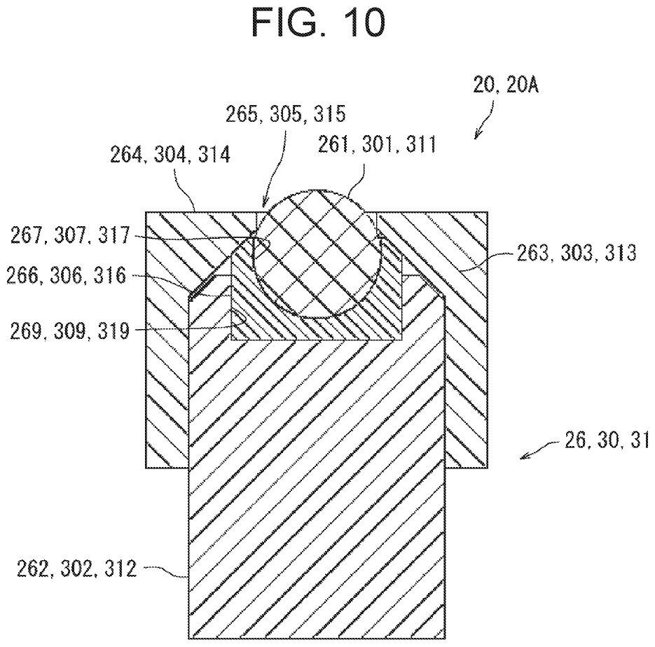

FIG. 8 is an enlarged perspective view of a second mount 20B provided in the head unit 16 according to the first embodiment. FIG. 9 is an external perspective view illustrating a Z-direction positioning member 26 provided in the head unit 16 according to the first embodiment. FIG. 10 is a cross-sectional view illustrating the Z-direction positioning member 26 provided in the head unit 16 according to the first embodiment.

In the first embodiment, the head unit 16 includes a mount 20 (first mount 20A). The inkjet head 15 includes a nozzle for ejecting ink. The mount 20 includes a Z-direction biasing member 27 and the Z-direction positioning member 26. The Z-direction positioning member 26 grips a sphere (spheres 261, 301 and 311) to be rotatable, and brings the sphere (spheres 261, 301 and 311) into contact with the inkjet head 15 to position the inkjet head 15 in the ink ejecting direction (Z (+) direction, lower direction) of the nozzle. The Z-direction biasing member 27 biases the inkjet head 15 to the Z-direction positioning member 26.

In the first embodiment, the head unit 16 further includes an X-direction positioning member 24, a Y-direction positioning member 25, an X-direction biasing member 21, and a Y-direction biasing member 22. The X-direction positioning member 24 positions the inkjet head 15A in a direction perpendicular to the ink ejecting direction (X direction).

The Y-direction positioning member 25 holds the inkjet head 15A to be rotatable in the vertical direction (X direction). In other words, the Y-direction positioning member 25 holds the inkjet head 15A to be rotatable in a plane perpendicular to the Z direction. The X-direction biasing member 21 biases the inkjet head 15A to the X-direction positioning member 24. The Y-direction biasing member 22 biases the inkjet head 15A to the Y-direction positioning member 25.

Hereinafter, the present embodiment will be described in detail. The configuration of the headset 11 will be described with reference to FIG. 2. Since the headsets 12 to 14 in FIG. 1 are different from the headset 11 only in the color of the built-in ink and are similar in structure to the headset 11, the description thereof will be omitted.

The headset 11 in FIG. 2 is illustrated upside down from the headset 11 in FIG. 1 to facilitate the explanation and the visual recognition. That is, FIG. 2 is a perspective view of the headset 11 in FIG. 1 as viewed from the downward oblique direction.

As illustrated in FIG. 2, the headset 11 includes the head unit 16. The head unit 16 includes the mount 20 (mounts 20A to 20F).

The inkjet head 15A can be attached to and detached from the first mount 20A and the second mount 20B. The inkjet head 15B can be attached to and detached from the first mount 20C and the second mount 20D. The inkjet head 15C can be attached to and detached from the first mount 20E and the second mount 20F.

The first mount 20A and the second mount 20B position the inkjet head 15A. The first mount 20C and the second mount 20D position the inkjet head 15B. The first mount 20E and the second mount 20F position the inkjet head 15C.

Further, the inkjet head 15A, the inkjet head 15B, and the inkjet head 15C are arranged to be displaced in the front-rear direction (main scanning direction) in FIG. 2. The inkjet head 15B and the inkjet head 15C are disposed at the same position in the left-right direction (sub scanning direction) in FIG. 2. The inkjet head 15A is placed so as to be displaced from the inkjet head 15B and the inkjet head 15C in the left-right direction (sub scanning direction) in FIG. 2.

Therefore, the inkjet head 15A, the inkjet head 15B, and the inkjet head 15C are arranged in a zigzag pattern with each other in a state of being attached to the respective mounts 20A to 20F.

The sheet S (FIG. 1) passes directly under the inkjet head 15A, the inkjet head 15B, and the inkjet head 15C in the (+) direction (sub scanning direction) of the X-axis, and ink is dropped from the inkjet head 15A, the inkjet head 15B, and the inkjet head 15C on the sheet S.

Since the inkjet heads 15A to 15C are arranged as described above, the nozzles arranged on the inkjet heads 15A to 15C are placed so that the nozzles are connected to or partially overlapped with each other in the main scanning direction. Since the nozzles are arranged in this manner, the ink can be dropped toward the entire width direction or substantially the entire width direction (main scanning direction) of the sheet S.

Next, the configuration of the inkjet head 15 will be described with reference to FIG. 3. The inkjet head 15 in FIG. 3 is illustrated upside down from FIG. 1 in the same manner as FIG. 2 to facilitate the explanation and the visual recognition. That is, FIG. 3 is a perspective view of the inkjet head 15 in FIG. 2 as viewed from the downward oblique direction. Further, since the inkjet heads 15A to 15C have the same structure, the inkjet head 15A will be described below unless otherwise specified.

The inkjet head 15A in FIG. 3 includes an ink tank (not illustrated), the nozzle surface 158, a nozzle (not illustrated), a front connecting portion 159, and a rear connecting portion 154. The ink tank is capable of storing ink. A large number of nozzles are formed on the nozzle surface 158 of the inkjet head 15A. The nozzle ejects the ink stored in the ink tank to the outside to drop the ink onto the sheet S.

In the inkjet head 15A, the length of the inkjet head 15A in the Y (+/−) direction is longer than the length of the inkjet head 15A in the X (+1-) direction in the XY plane. The Y (+/−) direction of the inkjet head 15A may be referred to as a longitudinal direction, and the X (+/−) direction may be referred to as a short direction. The inkjet head 15A includes the rear connecting portion 154 at one end side (rear end side) in the longitudinal direction.

A rear hole portion 155 is provided in the rear connecting portion 154, and the Z-direction biasing member 27, which will be described later in FIG. 6, is inserted into the rear hole portion 155. An example of the Z-direction biasing member 27 is a fastening screw. The rear connecting portion 154 can be attached to and detached from the first mount 20A by being tightened to the first mount 20A by the Z-direction biasing member 27.

The inkjet head 15A includes the front connecting portion 159 at the other end (front end) in the longitudinal direction. The front connecting portion 159 includes a front hole portion 153. A Z-direction biasing member 28, which will be described later in FIG. 6, is inserted into the front hole portion 153. An example of the Z-direction biasing member 28 is a fastening screw. The front connecting portion 159 can be attached to and detached from the second mount 20B by being tightened to the second mount 20B by the Z-direction biasing member 28.

A concave portion 156 is provided at the end of the front connecting portion 159 in the Y (−) direction. The concave portion 156 is engaged with the side surface of the Y-direction positioning member 25 to be slidable and rotatable, as will be described later in FIG. 5.

The shape of the concave portion 156 or at least a part thereof may be V-shaped on the XY plane. The shape of the Y-direction positioning member 25 may be circular, or the shape of a part thereof may be an arc on the XY plane. Since two planes forming the V-shape in the concave portion 156 are in contact with the arc portion of the Y-direction positioning member 25, the rotation axis centered on the Y-direction positioning member 25 is determined with high accuracy.

The concave portion 156 of the front connecting portion 159 is engaged with the side surface of the Y-direction positioning member 25 to be rotatable. Therefore, the inkjet head 15A can be rotated in the short direction (X (+/−) direction) of the inkjet head 15A as the Y-direction positioning member 25 as the center. Therefore, the user can easily position the inkjet head 15A in the short direction.

FIG. 4 illustrates an embodiment in which the inkjet head 15 is removed from the head unit 16 of the headset 11 in FIG. 2. Therefore, as in FIGS. 2 and 3, FIG. 4 is also illustrated upside down from FIG. 1. That is, FIG. 4 is a perspective view of the head unit 16 as viewed from the downward oblique direction.

As illustrated in FIG. 4, a set of the first mount 20A and the second mount 20B, a set of the first mount 20C and the second mount 20D, and a set of the first mount 20E and the second mount 20F are provided side by side in the front-rear direction (main scanning direction) of FIG. 4.

The configurations of the first mount 20A, the first mount 20C and the first mount 20E are similar to one another, and the configurations of the second mount 20B, the second mount 20D and the second mount 20F are similar to one another. Therefore, the first mount 20A and the second mount 20B will be described hereinafter unless otherwise specified.

FIG. 5 is an enlarged view of a part of the head unit 16 illustrated in the range surrounded by the dotted line A in FIG. 4. As in FIGS. 2 to 4, FIG. 5 is also illustrated upside down from FIG. 1.

FIG. 6 is an enlarged view of the first mount 20A illustrated in the range surrounded by the dotted line B in FIG. 5. FIG. 7 is an enlarged view of the second mount 20B illustrated in the range surrounded by the dotted line C in FIG. 5.

As illustrated in FIG. 5, the first mount 20A of the head unit 16 includes the X-direction biasing member 21, the Y-direction biasing member 22, the Z-direction biasing member 27, the X-direction positioning member 24, the Z-direction positioning member 26, and a spring 23.

An example of each of the X-direction biasing member 21 and the Y-direction biasing member 22 is a leaf spring. An example of the Z-direction positioning member 26 is a rotatable screw.

The second mount 20B of the head unit 16 includes the Y-direction positioning member 25, a Z-direction positioning member 30, a Z-direction positioning member 31, the Z-direction biasing member 28, and a spring 32.

When the inkjet head 15A is attached to the head unit 16, the rear connecting portion 154 of the inkjet head 15A is attached to the first mount 20A as illustrated in FIG. 6, and the front connecting portion 159 of the inkjet head 15A is attached to the second mount 20B as illustrated in FIG. 7.

The structure and function of the Z-direction positioning member 30 and the Z-direction positioning member 31 are the same as those of the Z-direction positioning member 26.

In the first mount 20A of the head unit 16 in FIG. 6, the Z-direction biasing member 27 and the Z-direction positioning member 26 position the inkjet head 15 in the ink ejecting direction (Z (−) direction or lower direction) of the nozzle.

Further, in the first mount 20A of the head unit 16, the X-direction biasing member 21 and the X-direction positioning member 24 position the inkjet head 15A in a direction (X direction or right-left direction) perpendicular to the ink ejecting direction (Z (−) direction or lower direction).

Further, the first mount 20A of the head unit 16 is provided with the Y-direction biasing member 22, and the second mount 20B of the head unit 16 is provided with the Y-direction positioning member 25. Accordingly, the Y-direction biasing member 22 and the Y-direction positioning member 25 position the inkjet head 15 in a direction (Y direction or front-rear direction) perpendicular to the ink ejecting direction (Z (−) direction or lower direction).

According to the first embodiment, the inkjet head 15A is positioned in the ink ejecting direction (Z direction) with respect to the head unit 16. The inkjet head 15A is positioned in the two different directions (X and Y directions) perpendicular to the ink ejecting direction of the head unit 16.

More specifically, as illustrated in FIG. 6, the first mount 20A is provided with the Z-direction biasing member 27 and the Z-direction positioning member 26.

The Z-direction biasing member 27 and the Z-direction positioning member 26 position the rear connecting portion 154 provided on one end side of the inkjet head 15A to the head unit 16 toward the ink ejecting direction (Z (−) direction or lower direction) of the nozzle arranged on the nozzle surface 158 of the inkjet head 15A or toward the short direction of the inkjet head 15A in FIG. 3.

The spring 23 is attached to the Z-direction biasing member 27. As will be described later in FIG. 8, the spring 23 is shortened from its natural length in the Z direction, for example. Therefore, the spring 23 has a force that tends to extend to the natural length so that the Z-direction biasing member 27 biases the rear connecting portion 154 provided on one end side of the head unit 16 toward the Z (+) direction (pulls in the Z (+) direction).

When the Z-direction positioning member 26 is a screw, the Z-direction positioning member 26 can adjust the height or position in the Z (+/−) direction or the upper-lower direction, and positions the rear connecting portion 154 provided on the one end side of the inkjet head 15A on the head unit 16.

Further, the Z-direction positioning member 26 adjusts the height of the inkjet head 15A with respect to the head unit 16 or the inclination of the inkjet head 15A with respect to the head unit 16.

The Z-direction positioning member 26 grips the sphere 261 to be rotatable. The sphere 261 abuts against the inkjet head 15A. As a result, the frictional force between the inkjet head 15A and the Z-direction positioning member 26 is reduced, and the movement and fine adjustment of the inkjet head 15A are facilitated.

As illustrated in FIG. 6, the first mount 20A is provided with the X-direction biasing member 21 and the X-direction positioning member 24.

The X-direction biasing member 21 and the X-direction positioning member 24 position the rear connecting portion 154 provided on the one end side of the inkjet head 15A to the head unit 16 toward the direction perpendicular to the ink ejecting direction (left-right direction or X (+/−) direction illustrated in FIG. 3) or the short direction of the inkjet head 15.

A X-direction adjusting screw 241 can penetrate the X-direction positioning member 24. An example of the X-direction adjusting screw 241 is a screw.

The user can adjust the position of the rear connecting portion 154 of the inkjet head 15A in the X direction by adjusting the penetration amount of the X direction adjusting screw 241. In other words, the rear connecting portion 154 of the inkjet head 15A is positioned by being sandwiched by the X-direction biasing member 21 and the X-direction positioning member 24.

The front connecting portion 159 of the inkjet head 15A is engaged by the Y-direction positioning member 25 to be slidable and rotatable. Therefore, the user can adjust the angle of the inkjet head 15A in the XY plane by adjusting the penetration amount of the X direction adjusting screw 241.

As illustrated in FIG. 6, the first mount 20A is provided with the Y-direction biasing member 22. As illustrated in FIG. 7, the second mount 20B is provided with the Y-direction positioning member 25. An example of the Y-direction positioning member 25 is a projection made of metal or resin.

That is, the Y-direction biasing member 22 and the Y-direction positioning member 25 position the rear connecting portion 154 provided on the one end side of the inkjet head 15A and the front connecting portion 159 provided on the other end side of the inkjet head 15A to the head unit 16 toward the direction perpendicular to the ink ejecting direction (front-rear direction or Y (+/−) direction in FIG. 3) or the longitudinal direction of the inkjet head 15.

As illustrated in FIG. 7, the Y-direction positioning member 25 is a projection extending in the Z (−) direction from the front connecting portion 159. The concave portion 156 of the front connecting portion 159 of the inkjet head 15A can be engaged with the side surface of the Y-direction positioning member 25. That is, the concave portion 156 of the front connecting portion 159 of the inkjet head 15A is biased by the Y-direction biasing member 22 to the side surface of the Y-direction positioning member 25 of the second mount 20B.

The concave portion 156 of the front connecting portion 159 is biased to and engaged with the Y-direction positioning member 25, so that the inkjet head 15A is positioned in the Y-direction.

Further, while the concave portion 156 of the front connecting portion 159 of the inkjet head 15A is engaged with the Y-direction positioning member 25, the inkjet head 15A can rotate in the circumferential direction around the Y-direction positioning member 25. The rotatable inkjet head 15A is positioned by the X-direction biasing member 21 and the X-direction positioning member 24 of the first mount 20A.

According to the first embodiment, since the sphere 261 of the Z-direction positioning member 26 comes into contact with the inkjet head 15A, the frictional force between the inkjet head 15A and the Z-direction positioning member 26 is reduced, and the movement of the inkjet head 15A is facilitated in the XY plane. Therefore, the user can easily perform the positioning of the inkjet head 15A in the X and Y directions, and the fine adjustment of the angle of the inkjet head 15A in the XY plane.

Further, according to the first embodiment, when the concave portion 156 of the front connecting portion 159 of the inkjet head 15A is engaged with the Y-direction positioning member 25, the inkjet head 15A can be rotated in the circumferential direction around the Y-direction positioning member 25. Therefore, the user can more easily perform the positioning of the inkjet head 15A in the X and Y directions and the fine adjustment of the angle of the inkjet head 15A in the XY plane.

As illustrated in FIG. 7, the second mount 20B includes the Z-direction positioning member 30, the Z-direction positioning member 31, the Z-direction biasing member 28, and the spring 32. The structure of the Z-direction positioning member 30 and the Z-direction positioning member 31 may be the same as that of the Z-direction positioning member 26 in FIG. 6.

The structure of the Z-direction biasing member 28 may be the same as that of the Z-direction biasing member 27 in FIG. 6. The structure of the spring 32 may be the same as that of the spring 23 in FIG. 6. Therefore, the description for the structure of the Z-direction biasing member 28 and the spring 32 is omitted.

In the first embodiment, at least one Z-direction positioning member 26 of the head unit 16 is disposed on the one end side of the inkjet head 15A, and a plurality of Z-direction positioning members 26 are disposed on the other end side of the inkjet head 15A.

The Z-direction positioning member 30 and the Z-direction positioning member 31 mainly exercise a function of supporting the inkjet head 15A horizontally (in the X and Y directions).

According to the present embodiment, the stability of the inkjet head 15A with respect to the first mount 20A of the head unit 16 is increased. The stability of the inkjet head 15A with respect to the second mount 20B of the head unit 16 is increased. As a result, the stability of the inkjet head 15A with respect to the head unit 16 is increased.

Next, the first mount 20A will be described in more detail with reference to FIG. 8. FIG. 8 is a cross-sectional view of the first mount 20A and the inkjet head 15A in the Z direction taken along line VIII-VIII in FIG. 6. As illustrated in FIG. 8, the rear connecting portion 154 of the inkjet head 15A is attached to the first mount 20A.

The first mount 20A includes a hollow portion 201 therein. The spring 23 is disposed in the hollow portion 201. The Z-direction biasing member 27 penetrates the rear hole portion 155 of the rear connecting portion 154, and further penetrates the cylindrical space surrounded by the spring 23 to be connected to the spring 23. For example, a disk-shaped member is attached to a screw at the tip of a fastening screw which is the Z-direction biasing member 27, and the spring 23 is placed in a state of being sandwiched between the disk-shaped member and a floor portion 202 of the cylindrical space. At this time, the spring 23 is sandwiched while being contracted more than its natural length in the Z direction.

Since the spring 23 tends to extend to the natural length, the Z-direction biasing member 27 is pulled by the spring 23 in the Z (+) direction (the direction of the arrow D).

A top portion 271 of the Z-direction biasing member 27 is engaged with the end portion of the rear hole portion 155. Therefore, since the Z-direction biasing member 27 is pulled in the direction of the arrow D, the rear connecting portion 154 of the inkjet head 15A is biased toward the first mount 20A.

As illustrated in FIG. 8, the first mount 20A further includes the Z-direction positioning member 26. The Z-direction positioning member 26 grips the sphere 261 to be rotatable. The sphere 261 abuts on the rear connecting portion 154 of the inkjet head 15A.

The rear connecting portion 154 of the inkjet head 15A is biased by the Z-direction biasing member 27 and the spring 23 to the Z-direction positioning member 26 of the first mount 20A. Since the Z-direction positioning member 26 grips the sphere 261 to be rotatable, the frictional force between the inkjet head 15A and the Z-direction positioning member 26 is reduced, and the movement of the inkjet head 15A is facilitated in the XY plane.

Next, the Z-direction positioning member 26 will be described with reference to FIGS. 9 and 10. FIG. 9 is an external perspective view illustrating the Z-direction positioning member 26 provided on the head unit 16 according to the first embodiment. FIG. 10 is a cross-sectional view illustrating the Z-direction positioning member 26 provided on the head unit 16 according to the first embodiment. FIG. 10 is a cross-sectional view of the Z-direction positioning member 26 taken along the line X-X in FIG. 9.

As illustrated in FIGS. 9 and 10, the Z-direction positioning member 26 includes a main body portion 262, a cap portion 263, a spacer 266, and the sphere 261.

As illustrated in FIG. 9, a screw thread and a screw groove on the male screw side (not illustrated) are provided on the outer peripheral surface of the main body portion 262. A screw thread and a screw groove on the female screw side (not illustrated) are provided on the inner peripheral surface (not illustrated) of the cap portion 263. Since the user rotates the cap portion 263 such that the main body portion 262 is covered with the cap portion 263, the cap portion 263 is engaged with and fitted into the main body portion 262.

The sphere 261 can be grasped by the main body portion 262. The cap portion 263 is provided with a through hole 265 penetrating from a ceiling portion 264 to the cavity on the back side of the ceiling portion 264. When the cap portion 263 is fitted into the main body portion 262, a part of the sphere 261 is exposed from the through hole 265.

As illustrated in FIG. 10, the Z-direction positioning member 26 may further include the spacer 266. The main body portion 262 may have a concave portion 269 into which the spacer 266 can be fitted. The spacer 266 includes a gripping portion 267 that can grip the sphere 261. The sphere 261 is grasped by the spacer 266. The sphere 261 can be grasped by the main body portion 262 via the spacer 266.

The user attaches the spacer 266 to the concave portion 269 of the main body portion 262, and fits the sphere 261 into the gripping portion 267 of the spacer 266. Then, the user rotates the cap portion 263 over the main body portion 262, and fits and fixes the cap portion 263 in the main body portion 262. When the cap portion 263 is fitted into the main body portion 262, a part of the sphere 261 is exposed from the through hole 265 of the cap portion 263.

As illustrated in FIGS. 7, 9 and 10, the Z-direction positioning members 30 and 31 have the same structure as the Z-direction positioning member 26, and therefore the duplicated detailed description thereof will be omitted.

The Z-direction positioning member 30 includes a main body portion 302, a cap portion 303, a spacer 306, and the sphere 301. The main body portion 302 includes a concave portion 309. The cap portion 303 includes a ceiling portion 304 and a through hole 305. The spacer 306 includes a gripping portion 307.

The Z-direction positioning member 31 includes a main body portion 312, a cap portion 313, a spacer 316, and the sphere 311. The main body portion 312 includes a concave portion 319. The cap portion 313 includes a ceiling portion 314 and a through hole 315. The spacer 316 includes a gripping portion 317.

### Second Embodiment

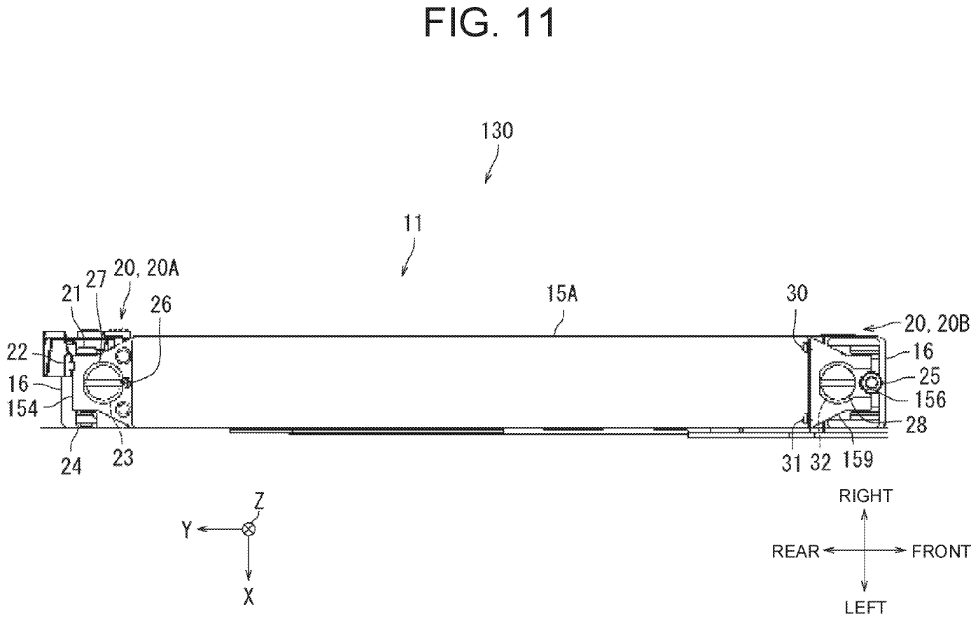

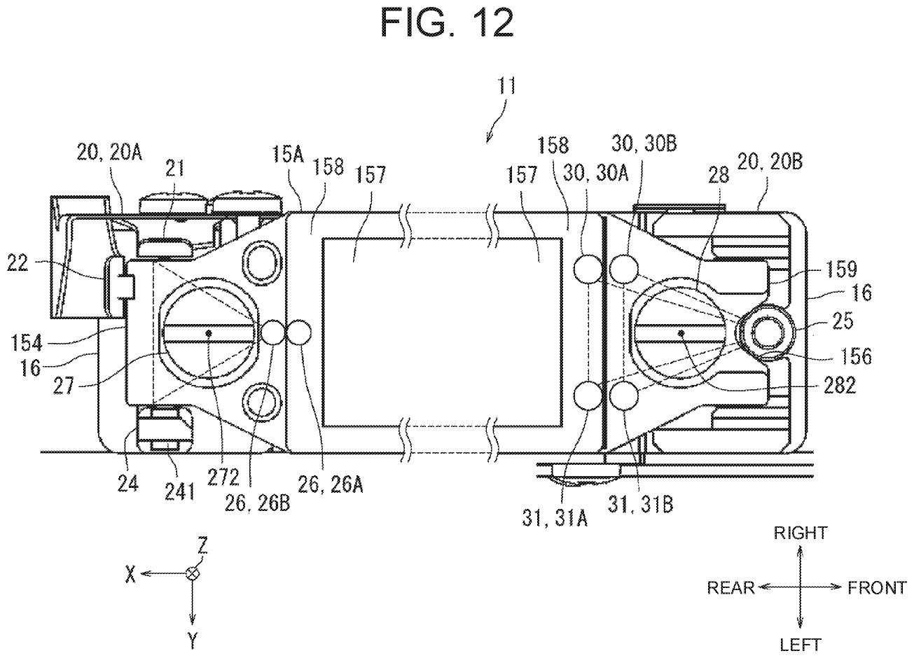

Next, a second embodiment of the present disclosure will be described with reference to FIGS. 11 and 12. FIG. 11 is a top view illustrating the head unit 16 according to the second embodiment. FIG. 12 is a top view illustrating the head unit 16 according to the second embodiment, and is an enlarged view of FIG. 11.

FIG. 11 illustrates an embodiment in which the inkjet head 15A is attached to the head unit 16. The head unit 16 includes the first mount 20A and the second mount 20B. The inkjet head 15A includes the front connecting portion 159 and the rear connecting portion 154.

The front connecting portion 159 of the inkjet head 15A is engaged to be rotatable with the Y-direction positioning member 25 of the second mount 20B. The rear connecting portion 154 of the inkjet head 15A is positioned in the X direction by the X direction biasing member 21 and the X-direction positioning member 24 of the first mount 20A. Further, the rear connecting portion 154 of the inkjet head 15A is positioned in the Y direction by the Y-direction biasing member 22 of the first mount 20A and the Y-direction positioning member 25 of the second mount 20B.

Further, the inkjet head 15A is positioned in the Z direction by the Z-direction positioning member 30 and the Z-direction positioning member 31 on the side of the front connecting portion 159. The inkjet head 15A is positioned in the Z direction by the Z-direction biasing member 27 and the Z-direction positioning member 26 on the side of the rear connecting portion 154. As the Z-direction positioning member 26, a Z-direction positioning member 26A or a Z-direction positioning member 26B is disposed.

In the second embodiment, as illustrated in FIG. 12, the Z-direction biasing member 27 or the Z-direction biasing member 27 is disposed in the range of a substantial triangle connecting the X-direction biasing member 21 or the Y-direction biasing member 22, the X-direction positioning member 24, and the Z-direction positioning member 26 at one end side of the head unit 16 (rear connecting portion 154 side, rear side, or Y (+) direction).

That is, in the second embodiment, the X-direction biasing member 21 or the Y-direction biasing member 22, the X-direction positioning member 24, and the Z-direction positioning member 26 (26A or 26B) are arranged at the apexes of the substantial triangle as indicated by the dotted line in the XY plane view. Then, the Z-direction biasing member 27 is arranged in the range of the substantial triangle. This means that the Z-direction biasing member 27 is disposed at a position overlapping the range surrounded by the substantial triangle.

Specifically, for example, a biasing center 272 of the Z-direction biasing member 27 is disposed within the range surrounded by the substantial triangle. Preferably, the biasing center 272 of the Z-direction biasing member 27 is arranged at the area center of gravity of the triangle.

Note that the biasing center 272 of the Z-direction biasing member 27 is a point where a resultant force of the entire biasing force applied from the Z-direction biasing member 27 to the inkjet head 15A is applied. Further, the biasing center 272 is structurally the area center of gravity of a portion where the Z-direction biasing member 27 and the inkjet head 15A are in contact with each other. Furthermore, the biasing center 272 is structurally a shaft of a fastening screw which is the Z-direction biasing member 27.

More specifically, the apex of the substantial triangle is a portion of the X-direction biasing member 21 in contact with the inkjet head 15A. Similarly, with respect to the Y-direction biasing member 22, the X-direction positioning member 24, and the Z-direction positioning member 26, each apex of the substantial triangle is a portion where the Y-direction biasing member 22, the X-direction positioning member 24, and the Z-direction positioning member 26 contact the inkjet head 15A.

The reason why the name “substantial triangle” is used here is that there is a size in the portion to be each apex. More specifically, the substantial triangle is a shape formed by connecting the outer sides of portions each to be the apex so as to form a larger triangle.

According to the present embodiment, the stability of the inkjet head 15A with respect to the first mount 20A of the head unit 16 is increased. As a result, the stability of the inkjet head 15A with respect to the head unit 16 is increased.

The more equilateral the shape of the constructed triangle, the greater the stability. The ratio of the height to the base of the constructed triangle may be 0.5 or more and 2 or less regardless of which side is the base.

Further, in the triangle, the stability increases as the biasing center gets closer to the area center of gravity of the triangle. The ratio of the length of a line connecting the area center of gravity and the biasing center to the length of an imaginary line extending from the area center of gravity toward the biasing center until the imaginary line reaches the edge or apex of the triangle may be 0.5 or less.

A plurality of Z-direction positioning members may be disposed in the rear connecting portion 154. In this case, it is sufficient that one of them satisfies the above condition. However, the stability is increased when the number of Z-direction positioning members arranged in the rear connecting portion 154 is one.

### Third Embodiment

Next, a third embodiment of the present disclosure will be described with reference to FIG. 12. As the Z-direction positioning member 30, a Z-direction positioning member 30A or a Z-direction positioning member 30B is disposed. As the Z-direction positioning member 31, a Z-direction positioning member 31A or a Z-direction positioning member 31B is disposed.

As illustrated in FIG. 12, in the other end side of the head unit 16 (front connecting portion 159 side, front side or Y (−) direction), the Z-direction biasing member 28 or the Z-direction biasing member 28 is disposed in the range of the triangle connecting the Y-direction positioning member 25, the Z-direction positioning member 30, and the Z-direction positioning member 31.

In the third embodiment, the Y-direction positioning member 25, the Z-direction positioning member 30 (30A or 30B), and the Z-direction positioning member 31 (31A or 31B) are disposed at the apexes of the substantial triangle as indicated by dotted lines in the XY plane view. Then, the Z-direction biasing member 28 is arranged in the range of the substantial triangle. This means that the Z-direction biasing member 28 is disposed at a position overlapping the range surrounded by the substantial triangle.

Specifically, for example, a biasing center 282 of the Z-direction biasing member 28 is disposed within the range surrounded by the substantial triangle. Preferably, the biasing center 282 of the Z-direction biasing member 28 is disposed at the area center of gravity of the substantial triangle.

Note that the biasing center 282 of the Z-direction biasing member 28 is a point where a resultant force of the entire biasing force applied from the Z-direction biasing member 28 to the inkjet head 15A is applied. Further, the biasing center 282 is structurally the area center of gravity of the portion where the Z-direction biasing member 28 is in contact with the inkjet head 15A. Furthermore, the biasing center 282 is structurally a shaft of a fastening screw which is the Z-direction biasing member 27.

More specifically, the apex of the substantial triangle is a portion where the Y-direction positioning member 25 is in contact with the inkjet head 15A. Similarly, with respect to the Z-direction positioning member 30 and the Z-direction positioning member 31, the portions where these members 30 and 31 are in contact with the inkjet head 15A becomes the respective apexes of the substantial triangle.

The reason why the name “substantial triangle” is used here is that there is a size in the portion to be each apex. More specifically, the substantial triangle is a shape formed by connecting the outer sides of portions each to be the apex so as to form a larger triangle.

According to the present embodiment, the stability of the inkjet head 15A with respect to the second mount 20B of the head unit 16 is increased. As a result, the stability of the inkjet head 15A with respect to the head unit 16 is increased.

The more equilateral the shape of the constructed triangle, the greater the stability. The ratio of the height to the base of the constructed triangle may be 0.5 or more and 2 or less regardless of which side is the base.

Further, in the triangle, the stability increases as the biasing center gets closer to the area center of gravity of the triangle. The ratio of the length of a line connecting the area center of gravity and the biasing center to the length of an imaginary line extending from the area center of gravity toward the biasing center until the imaginary line reaches the edge or apex of the triangle may be 0.5 or less.

Three or more Z-direction positioning members may be disposed in the front connecting portion 159. In this case, it is sufficient that two of them satisfies the above condition. However, the stability is increased when the number of Z-direction positioning members disposed in the front connecting portion 159 is two.

### Fourth Embodiment

Next, a fourth embodiment of the present disclosure will be described with reference to FIG. 12. According to the fourth embodiment, in the inkjet head 15A, when the one end side (rear side, rear connecting portion 154 side or X (+) direction side) of the inkjet head 15A is viewed from the center of the inkjet head 15A in the longitudinal direction (front-rear direction or X (+1-) direction), the X-direction biasing member 21 or the Y-direction biasing member 22, the Z-direction biasing member 27, and the Z-direction positioning member 26 are arranged in this order from the one end of the inkjet head 15A toward the center of the inkjet head 15A in the longitudinal direction.

As illustrated in FIG. 12, in the rear connecting portion 154 of the inkjet head 15A, the X-direction biasing member 21 or the Y-direction biasing member 22, the Z-direction biasing member 27, and the Z-direction positioning member 26 (Z-direction positioning member 26B and Z-direction positioning member 26A) are arranged in this order from the rear side to the front side of the head unit 16.

More specifically, when the rear connecting portion 154 of the inkjet head 15A is viewed from the center of the inkjet head 15A in the longitudinal direction (X direction or front-rear direction), the Z-direction positioning member 26 and the Z-direction biasing member 27 for positioning the rear connecting portion 154 in the ink ejecting direction (Z (+) direction or upper direction) are arranged in the order of the X direction biasing member 21 and the Y-direction biasing member 22 for positioning the rear connecting portion 154 in the X and Y directions or left-right and front-rear directions, the Z-direction biasing member 27, and the Z-direction positioning member 26 (Z-direction positioning member 26A and Z-direction positioning member 26B).

According to the present embodiment, the stability of the inkjet head 15A with respect to the first mount 20A of the head unit 16 is increased. As a result, the stability of the inkjet head 15A with respect to the head unit 16 is increased.

### Fifth Embodiment

Next, a fifth embodiment of the present disclosure will be described with reference to FIG. 12. According to the fifth embodiment, in the head unit 16, when the other end side (front side, X (−) direction side or front connecting portion 159 side) of the inkjet head 15 is viewed from the center of the inkjet head 15 in the longitudinal direction (Y direction or front-rear direction), the Y-direction positioning member 25, the Z-direction biasing member 28, the Z-direction positioning member 30, and the Z-direction positioning member 31 are arranged in this order from the other end of the inkjet head 15 toward the center of the inkjet head 15 in the longitudinal direction.

As illustrated in FIG. 12, in the front connecting portion 159 of the inkjet head 15A, the Y-direction positioning member 25, the Z-direction biasing member 28, and the Z-direction positioning member 30 (Z-direction positioning member 30B, Z-direction positioning member 30A, Z-direction positioning member 31B, and Z-direction positioning member 31A) are arranged in this order from the front side to the rear side of the head unit 16.

More specifically, when the front connecting portion 159 of the inkjet head 15A is viewed from the center of the inkjet head 15A in the longitudinal direction (X (+/−) direction or front-rear direction), the Z-direction positioning member 30 (Z-direction positioning member 30A and Z-direction positioning member 30B) for positioning the front connecting portion 159 in the ink ejecting direction (Z (−) direction or lower direction) and the Z-direction positioning member 31 (Z-direction positioning member 31A and Z-direction positioning member 31B) are provided on the front side of the Y-direction positioning member 25 for locking the front connecting portion 159.

According to the present embodiment, the stability of the inkjet head 15A with respect to the second mount 20B of the head unit 16 is increased. As a result, the stability of the inkjet head 15A with respect to the head unit 16 is increased.

### Sixth Embodiment

Next, a sixth embodiment of the present disclosure will be described with reference to FIG. 12. As illustrated in FIG. 12, the inkjet head 15A includes a nozzle region 157 including a plurality of nozzles on a part of the nozzle surface 158.

In the sixth embodiment, the inkjet head 15A includes the nozzle region 157 in which the nozzles are arranged. When the head unit 16 including the inkjet head 15A mounted on the mount 20 is viewed in the ink ejecting direction (Z (−) direction), either the Z-direction positioning member 26, the Z-direction positioning member 30, or the Z-direction positioning member 31 is arranged outside the nozzle region 157 in which the nozzles are arranged in the inkjet head 15A.

That is, when the head unit 16 including the inkjet head 15A mounted on the mount 20 is viewed (by the user) in the ink ejecting direction (Z (−) direction), either the Z-direction positioning member 26A, the Z-direction positioning member 26B, the Z-direction positioning member 30A, the Z-direction positioning member 30B, the Z-direction positioning member 31A, or the Z-direction positioning member 31B of the head unit 16 is disposed outside the nozzle region 157 of the nozzle surface 158 of the inkjet head 15A.

According to the present embodiment, the deformation in which the nozzle surface 158 bends in the ink ejecting direction (Z (+1-) direction) is less likely to occur in the nozzle region 157 due to the stress at the time of mounting the inkjet head 15A, and the printing accuracy is improved.

Further, the Z-direction positioning member 26A, the Z-direction positioning member 26B, the Z-direction positioning member 30A, the Z-direction positioning member 30B, the Z-direction positioning member 31A, and the Z-direction positioning member 31B can be easily designed, and therefore, the design of the inkjet head 15A can be facilitated.

### Seventh Embodiment

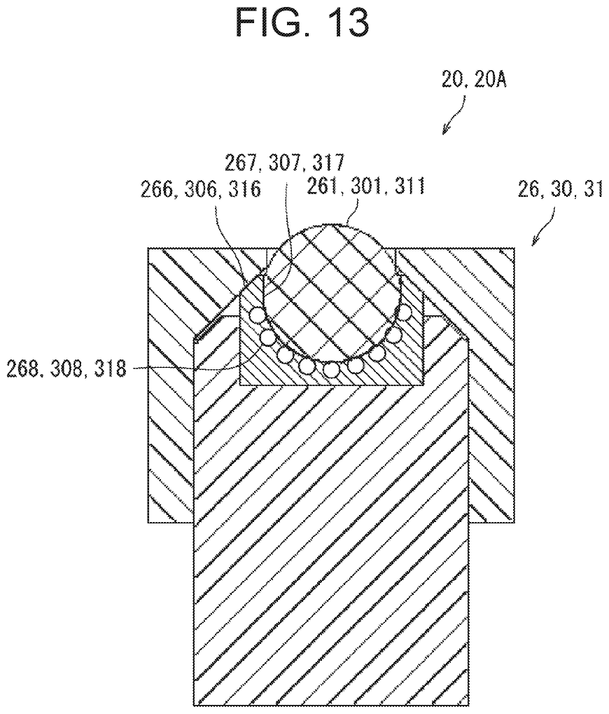

Next, a seventh embodiment will be described with reference to FIG. 13. FIG. 13 is a cross-sectional view illustrating the Z-direction positioning member 26 provided on the head unit 16 according to the seventh embodiment.

In the seventh embodiment, the Z-direction positioning member 26 (Z-direction positioning member 26A and Z-direction positioning member 26B) of the head unit 16 includes the gripping portion 267 for holding the sphere 261. The gripping portion 267 includes a bearing 268 for holding the sphere 261.

The Z-direction positioning member 30 (Z-direction positioning member 30A and Z-direction positioning member 30B) includes a gripping portion 307 for holding the sphere 301. The gripping portion 307 includes a bearing 308 for holding the sphere 301.

The Z-direction positioning member 31 (Z-direction positioning member 31A and Z-direction positioning member 31B) includes the gripping portion 317 for holding the sphere 311. The gripping portion 317 includes a bearing 318 for holding the sphere 311 to be rotatable.

That is, as illustrated in FIG. 13, the Z-direction positioning member 26 includes the plurality of bearings 268 along the surface forming the gripping portion 267 of the spacer 266. The bearing 268 is partially embedded in the gripping portion 267. The sphere 261 abuts on the plurality of bearings 268 to be rotatable when the sphere 261 is attached to the spacer 266.

Similarly, the Z-direction positioning member 30 includes the plurality of bearings 308 along the surface forming the gripping portion 307 of the spacer 306. The bearing 308 is partially embedded in the gripping portion 307. The sphere 301 abuts on the plurality of bearings 308 to be rotatable when the sphere 301 is attached to the spacer 306.

Similarly, the Z-direction positioning member 31 includes the plurality of bearings 318 along the surface forming the gripping portion 317 of the spacer 316. The bearing 318 is partially embedded in the gripping portion 317. The sphere 311 abuts on the plurality of bearings 318 to be rotatable when the sphere 311 is attached to the spacer 316.

According to the present embodiment, the frictional force between the sphere 261 and the spacer 266 can be further reduced as compared with the Z-direction positioning member 26 of the first embodiment in FIG. 10.

According to the present embodiment, the frictional force between the sphere 301 and the spacer 306 can be further reduced as compared with the Z-direction positioning member 30 of the first embodiment in FIG. 10.

According to the present embodiment, the frictional force between the sphere 311 and the spacer 316 can be further reduced as compared with the Z-direction positioning member 31 of the first embodiment in FIG. 10.

Further, in the image forming device 100, the user can position the inkjet head with respect to the head unit in a finely adjustable manner.

The embodiments of the present disclosure have been described above with reference to the drawings. However, the present disclosure is not limited to the above-described embodiments, and can be implemented in various aspects without departing from the gist thereof. Further, various disclosures can be formed by appropriately combining the plurality of components disclosed in each of the above embodiments. For example, some components may be deleted from all the components illustrated in the present embodiments. Further, some components of different embodiments may be appropriately combined. In the drawings, for the sake of easy understanding, each component is schematically illustrated mainly, and the number and the like of each component illustrated in the drawings are different from the actual components for the convenience of drawing preparation. Further, the shape and the like of each component illustrated in the above embodiment is an example and is not particularly limited, and various modifications can be made without substantially departing from the configuration of the present disclosure.

The present disclosure is applicable to the field of a head unit and an image forming device.

What is claimed is:

1. A head unit comprising:
a mount on which an inkjet head is positioned,
wherein the inkjet head comprises a nozzle to eject ink,
wherein the mount comprises:
a Z-direction positioning member to grip a sphere to be rotatable and bring the sphere into contact with the inkjet head to position the inkjet head in an ink ejecting direction of the nozzle; and
a Z-direction biasing member to bias the inkjet head to the Z-direction positioning member.

2. The head unit according to claim 1, the head unit further comprising:
an X-direction positioning member to position the inkjet head in a vertical direction with respect to the ink ejecting direction;
a Y-direction positioning member to hold the inkjet head to be rotatable in the vertical direction;
an X-direction biasing member to bias the inkjet head to the X-direction positioning member; and
a Y-direction biasing member to bias the inkjet head to the Y-direction positioning member.

3. The head unit according to claim 2,
wherein the Z-direction positioning member comprises:
at least one Z-direction positioning member arranged on a side of one end of the inkjet head; and
a plurality of Z-direction positioning members arranged on a side of the other end of the inkjet head.

4. The head unit according to claim 3,
wherein the length of the inkjet head in Y direction is longer than the length of the inkjet head in X direction, and the one end and the other end are located at both ends of the inkjet head in the Y direction, and
wherein the X-direction biasing member or the Y-direction biasing member, the Z-direction biasing member, and the Z-direction positioning member are arranged in this order from the one end toward a center in a longitudinal direction.

5. The head unit according to claim 3,
wherein the length of the inkjet head in Y direction is longer than the length of the inkjet head in X direction, and the one end and the other end are located at both ends of the inkjet head in the Y direction, and
wherein the Y-direction biasing member, the Z-direction biasing member, and the Z-direction positioning member are arranged in this order from the other end toward a center in a longitudinal direction.

6. The head unit according to claim 3,
wherein at the side of one end, the Z-direction biasing member is arranged in a range of a substantial triangle connecting the X-direction biasing member or the Y-direction biasing member, the X-direction positioning member, and the Z-direction positioning member.

7. The head unit according to claim 3,
wherein at the side of other end, the Z-direction biasing member is arranged in a range of a substantial triangle connecting the Y-direction biasing member and two of the plurality of Z-direction positioning members.

8. The head unit according to claim 1,
wherein when the inkjet head mounted on the mount is viewed in the ink ejecting direction, the Z-direction positioning member is arranged outside a nozzle region in which the nozzle is arranged in the inkjet head.

9. The head unit according to claim 1,
wherein the Z-direction positioning member comprises a gripping portion to grip the sphere, and
wherein the gripping portion comprises a bearing to hold the sphere to be rotatable.

10. An image forming device comprising the head unit according to claim 1.
